(19) United States
(12) Patent Application Publication
(10) Pub. No.: US 2005/0234154 A1
(43) Pub. Date: Oct. 20, 2005

(54) Star-like polyolefin having high propylene content and polar derivatives thereof and method for its production

(75) Inventor: Izhar Halahmi, Hod Hasharon (IL)

Correspondence Address: DANIEL J SWIRSKY, PO BOX 2345, BEIT SHEMESH, 99544, IL

(73) Assignee: POLYRAM Ram-On Industries

(21) Appl. No.: 11/105,383

(22) Filed: Apr. 14, 2005

(30) Foreign Application Priority Data
Apr. 18, 2004 (IL) 161473

(51) Int. Cl. C08K 3/40

(52) U.S. Cl. 524/13; 524/494

(57) ABSTRACT

A composition of matter including a star-like high polypropylene (SHPP), the polypropylene manufactured by a continuous reactive process at molten phase and characterized by a comb-like, fork-like and/or star-like molecular structure, including polypropylene, ranging from about 80 to 99% of formula, free-radical initiator having T_{1/2} of at least 1 min at temperature higher than 100° C., ranging from about 0.01 to 2% of formula, one or more branching nucleus monomers (BMN) having two or more vinyl or allyl reactive groups, adapted to form at least one branch point when grafted onto the polypropylene, ranging from about 0.1 to 20% of formula, and one or more monomers having at least one vinyl or allyl reactive group, ranging from 0 to about 20% of formula.

### CROSS-REFERENCE TO RELATED APPLICATIONS

This application claims priority from Israel Patent Application No. 161,473, filed Apr. 18, 2004.

### FIELD OF THE INVENTION

The present invention generally relates to a Star-like polyolefin having high propylene content and polar derivatives thereof to a continuous reactive process for producing the same at a molten phase.

### BACKGROUND OF THE INVENTION

Grafting of polar monomers onto polypropylene (PP) is well known industrial process. The most common process is the grafting of maleic anhydride (hereinafter ‘MA’) onto the backbone chain of a polymer in the presence of organic peroxides.

Grafting of polar monomers onto polypropylene in continuous process in molten phase, unlike grafting in solution, is extensively provided as a reactive extrusion, wherein the reaction is carried in an extruder, usually a twin-screw type. Maleation of polypropylene in the presence of organic peroxide yields lower molecular weight products with a sharp increase in flow rate due to fragmentation during the maleation process. It is acknowledged in the art that higher the maleation level, the lower the molecular weight. Another problem related to high level of maleation is the yellow color of the product. At modification level of above 1% MA (w/w from product), the product is so high flow at extrusion temperature (usually 190 to 230° C.) that it is impossible to pull strands from it or to palletize it.

Many applications require combination of high maleation level with high strength and dimensional stability. Since higher level of maleation requires higher level of peroxide and longer residence time—the molecular weight deteriorates to levels that mechanical and physical properties are insufficient.

U.S. Pat. No. 5,955,547 to Roberts et al., discloses a composition of matter comprising a maleated polypropylene having an acid number greater than 6, a yellowness index color of no greater than 40, a number average molecular weight of at least 20,000, and a Brookfield Thermosel Melt Viscosity of at least about 16,000 cP at 190° C. Another patent to Eastman Chemical Company, namely U.S. Pat. No. 6,046,279 to Roberts et al., introduces a process for the production of maleated polypropylene. The process comprising the three steps of (a) continuously forming an intimate mixture of molten polypropylene and molten maleic anhydride at one end of a screw extruder; (b) continuously introducing a free radical initiator, such as ditertiary butyl peroxide, tertiary butyl hydroperoxide, cumene hydroperoxide, p-menthane peroxide, p-menthane hydroperoxide and 2,5-dimethyl-2,5-bis-(t-butylperoxy)hexane into said mixture to initiate the grafting of the maleic anhydride onto the molten polypropylene to produce a maleated polypropylene; and (c), continuously removing the product from the opposite end of the extruder.

Those claimed processes are underlined by several significant industrial drawbacks, namely squandering evaporation of a considerable portion of the MA during its melting, a severe environmental issue, difficulties in regulating the pumping the peroxide at accurate low levels along this continues process, and complicatedness in regulating the predetermined molecular weight of the product. The pumping of peroxide at levels of 0.05 to 1% relatively to the molten PP is very difficult to control and since the molecular weight is extremely sensitive to the peroxide level, it is almost impossible to control molecular weight, flow and physical properties. Another problem is that the feeding of liquid into molten PP, which is under high pressure inside the extruder, results in blocking of peroxide nozzles.

Unlike maleic anhydride, acrylic acid and methacrylic acid or esters thereof, and non-polar monomer such as styrene, does homo-polymerize, thus able to be used as grafting regulators of maleic anhydride at lower residence times. Where these regulators are polar or acidic, the overall polarity of the modified polyolefin is increased. Unlike styrene, which is a good regulator but has significant odor and volatility limitations, acrylic acid esters and methacrylic acid esters, especially compositions comprising short polyol, polyester or polyurethane), have very low volatility and insubstantial odor. It is very important to be able to regulate the grafting of MA onto polyolefines by a co-monomer which is characterized by a low volatility and low toxicity, mild odor, good heat stability and clear homopolymers and copolymers, is reactive with both the MA ingredient and the polymer, and distinguished by a higher polarity as compared with the polymer.

It is yet another problem related to continuous maleation of polyolefines wherein the difference between bulk densities of the polymer pellets and the maleic anhydride powder is generating problems during feeding.

It is thus a long felt need to modify polypropylene by maleic anhydride in a process that creates minimal molecular weight deterioration in PP polymers, by simple feeding of the polymer, monomers, initiator and additives from one feeding port in the extruder. A novel structure where the PP is grafted and simultaneously rearranged into branched structure via multifunctional monomer is very important from economical and industrial standpoint.

### BRIEF DESCRIPTION OF THE DRAWINGS

In order to understand the invention and to see how it may be implemented in practice, a plurality of preferred embodiments will now be described, by way of non-limiting example only, with reference to the accompanying drawing, in which

FIG. 1 schematically presents the maleation process as know in the art and its-non-branched polar polypropylene;

FIG. 2 schematically presents the process according to one embodiment of the present invention and branched non-polar polypropylene products produced thereof;

FIG. 3 schematically presents the process according to still another embodiment of the present invention and branched polar products polypropylene produced thereof;

FIG. 4 schematically presents the process according to another embodiment of the present invention and branched multi-component polypropylene products produced thereof; and

FIG. 5 schematically presents the process according to another embodiment of the present invention wherein mono-acrylate and di- and tri- acrylate is highly polar, and polar branched multi-component polypropylene products produced thereof.

### SUMMARY OF THE INVENTION

The present invention thus provide for a novel composition of matter comprising a star-like high polypropylene (SHPP). Said polypropylene is manufactured by a continuous reactive process at molten phase and characterized by a comb-like, fork-like and/or star-like molecular structure, comprising: (a) polypropylene, ranging from about 80 to 99% of formula; (b) free-radical initiator having T½ of at least 1 min at temperature higher than 100° C., ranging from about 0.01 to 2% of formula; (c) one or more branching nucleus monomers (BMN) having two or more vinyl or allyl reactive groups, adapted to form at least one branch point when grafted onto said polypropylene, ranging from about 0.1 to 20% of formula; and, (d) one or more monomers having at least one vinyl or allyl reactive group, ranging from 0 to about 20% of formula.

It is in the scope of the present invention wherein the polypropylene is a homopolymer., and/or wherein the polypropylene is a copolymer, having about 1 to 80% co-monomer in formula.

It is also in the scope of the present invention wherein the BNM is characterized by the formula of R1;R2;R3(R4, R5); wherein at least-R1 is acrylic or methacrylic group, chemically connected to R2 via an ester group; wherein R2 is mono, di or oligomeric ether, ester and/or urethane chain, connected to R3 via either ester or ether group, wherein R2 is either a short polyester or polyurethane; wherein R3 has a plurality of n acrylate or methacrylate ester side groups, denoted as R4, connected to R3 via an ester group, wherein n is an integer number so that n≧0; and further wherein R5 is H, OH, CH3, glycidyl, acrylate or methacrylate ester, carboxyl or anhydride thereof connected to R3 via an ester group.

It is also in the scope of the present invention wherein the BNM comprising “rays” or “branches”. The number of branches is 2 or more. Each branch comprising at elast one unsaturated end-group selected from acrylic or methacrylic ester, connected via an ester group to mono, di or oligomeric ether, ester and/or urethane “spacer” that is connected to the “star” center via ether or ester group. A “star” or “comb” BNM may further comprise also reactive groups such as glycidyl and hydroxyl and may comprise additional acidic groups.

It is also in the scope of the present invention wherein the BNM is comprised of at least one of the group of vinyl esters, vinyl ethers, alkyd, unsaturated polyester, vinyl terminated PDMS, 1,2 polybutadiene, acrylic and methacrylic esters of polyhydric alcohols or any combinaton thereof, trimethylolpropanetriacrylate for example. The matter is possibly pelletizable.

It is also in the scope of the present invention wherein a composition of matter comprising a modified polar SHPP is disclosed. Said polypropylene is manufactured by a continuous reactive process at molten phase and characterized by a fork-like and/or star-like molecular structure, comprising (a) polypropylene ranging from about 80 to 99% of formula; (b) free radical initiator having T½ of lat least min. at temperature higher than 100° C., ranging from about 0.01 to 2% of formula; (c) one or more BNM monomers having two or more vinyl or allyl reactive groups ranging from about 0.1 to 20% of formula, adapted to form at least one branch point when grafted onto polypropylene; (d) one or more monomers having at least one vinyl or allyl reactive group, ranging from 0 to about 20% of formula; (e) unsaturated acid monomer having at least one vinyl or allyl reactive groups and one or more carboxylic acid or anhydride or ester group, ranging from about 0.1 to 5% of formula. Said polypropylene is possibly a homopolymer, and/or a copolymer, having about 1 to 80% co-monomer in formula.

It is also in the scope of the present invention wherein the unsaturated acid or any of its derivatives are selected from one or more of the group of maleic acid, esters or anhydride; acrylic acid, esters or anhydride; methacrylic acid, esters and anhydride or any mixture thereof.

It is also in the scope of the present invention wherein the BNM is characterized by the formula of R1;R2;R3(R4, R5); wherein at least one R1 is acrylic or methacrylic group, chemically connected to R2 via an ester group; wherein R2 is mono, di- or oligomeric ether, ester and/or urethane chain, connected to R3 via either ester or ether group, wherein R2 is either a short polyester or polyurethane; wherein R3 has a plurality of n acrylate or methacrylate ester side groups, denoted as R4, connected to R3 via an ester group, wherein n is an integer number so that n≧0; and further wherein R5 is H, OH, CH3, glycidyl, acrylate or methacrylate ester, carboxyl or anhydride thereof connected to R3 via an ester group.

The BNM is possibly selected from at least one of the group of vinyl esters, vinyl ethers, alkyd, unsaturated polyester, vinyl terminated PDMS, 1,2 polybutadiene, acrylic and methacrylic esters of polyhydric alcohols or any combination thereof. Said composition may also adapted to couple polyolefines with fillers and fibers.

It is also in the scope of the present invention wherein the fibers are synthetic fibers, natural fibers or any mixture thereof; and/or wherein the fibers are selected from wood, flour, glass, silica, minerals, metal, ceramic and organic pigments.

The composition defined above may be further be useful as an adhesive or adhesive building-block compositions for bonding plastics with at least one polar substrate.

It is also in the scope of the present invention wherein the polar substrate is selected from wood, paper, metals, polar plastics, glass, ceramics or a combination thereof, and/or wherein the composition is provided useful as a compatibilizer, having means for compatibiling incompatible thermoplastics. The incompatible thermoplastics are preferably selected from polypropylene/polyamide and/or polypropylene/polyester mixtures. Said composition may also be useful as a dispersing agent for pigments and/or nano-sized particles in plastic matrices. Moreover, said composition may also be useful as a primer for coatings and adhesives when applied onto plastic or natural polymers surfaces prior to application of coating or adhesive. Said matter is preferably, yet not exclusively being pelletizable.

It is another object of the present invention to disclose a continuous reactive process for producing SHPP as defined in any of the above. This method comprising inter alia the steps of (a) pre-mixing all ingredients so a homogeneous dry, free flowing pellets or powder blend is obtained; (b) during mixing, immobilizing the maleic anhydride dust by the liquid monomers into the polymer pellets or powder; (c) feeding the obtained free flowing mixture, by known feeding means into an extruder; while, usually co-rotating twin screw, heating the first zone of extruder to a temperature ranging from about 50 to 130° C. in the manner that the monomers and the initiator on the polymer pellets or powder are distributed evenly and the initiator is minimally activated; and, (d) reacting the ingredients under extensive mixing in the extruder at temperature range of about 160 to 235° C., residence time of about 0.5 to 3 minutes, screw speed of about 100 to 450 RPM, with a contentious removal of volatile materials under vacuum at the last section of extruder and contentious collecting the reacted product as palletizeable compound

### DETAILED DESCRIPTION OF THE EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a composition of matter comprising SHPP; and to provide a continuous reactive process at molten phase adapted to produced the same.

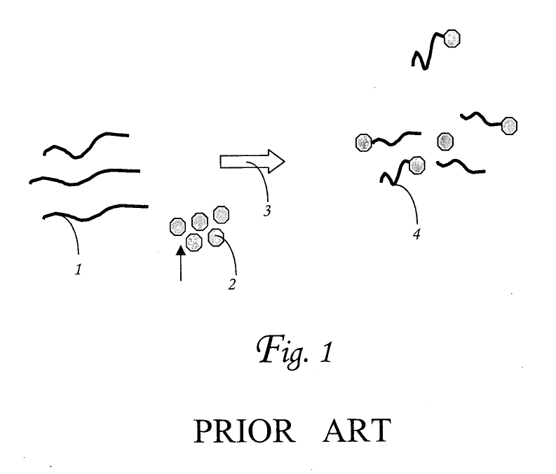

Reference is made now to FIG. 1, presenting the prior art, such as the aforesaid U.S. Pat. Nos. 5,955,547, 6,426,389 and U.S. patent application No. 2002/0026010 to Eastman Chemical Company, wherein polypropylene linear chains (1) are grafted by maleic anhydride (2) in a well known Maleation process (3), traditionally provided as a multi-steps and/or semi-continuous reaction carried out solely in a respectively long and expensive extruder. This skin-irritating reaction is underlined as a non-environmental friendly industrial process. The polar polypropylene straight chains obtained by reaction (3) are chopped along their longitudinal axis and terminated by MA groups (4).

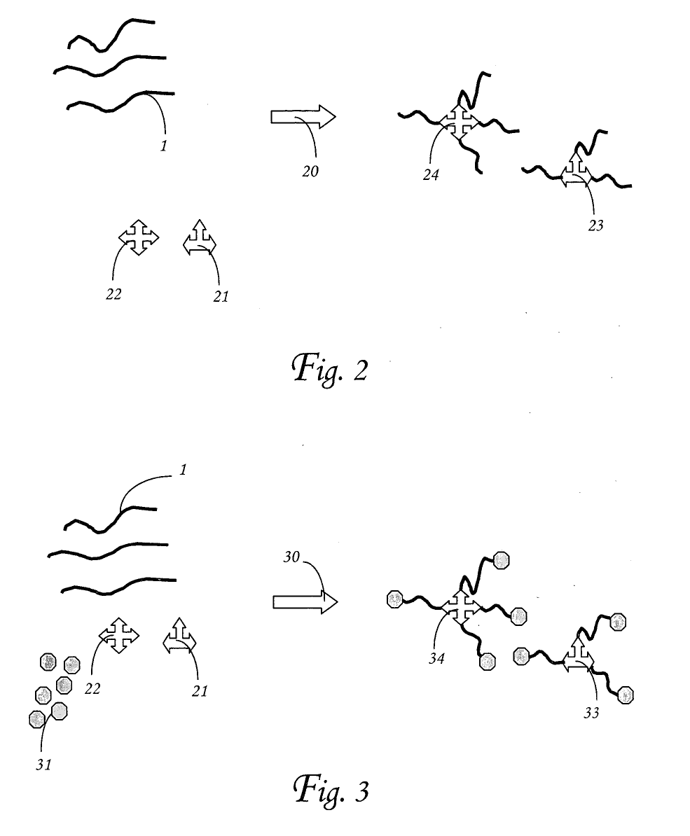

It is acknowledge in this respect that it is a long felt need to have high molecular weight (for enhanced properties) with high maleic anhydride content (for improved adhesion) and why our invention is so surprisingly due to this Surprisingly, the present invention is disclosing a novel composition of matter comprising inter alia or solely SHPP. Reference is made now to FIG. 2, schematically illustrating the core of the present invention, wherein the aforesaid SHPP (e.g., 23 or 24) is manufactured by an original continuous reactive process (20) at molten phase. Here, polypropylene segments (1) are reacted inter alia with BNMs of various shape, size and type (e.g., 21 or 22), which are characterized in a non-limiting manner from a comb like, fork-like and/or star-like molecular structure. SHPP (23, 24) are hence comprised of (i) polypropylene, ranging from about 80 to 99% of formula; (ii) free-radical initiator having T½ of at least 1 min at temperature higher than 100° C., ranging from about 0.01 to 2% of formula; (iii) one or more BNMs having two or more vinyl or allyl reactive groups, adapted to form at least one branch point when grafted onto said polypropylene, ranging from about 0.1 to 20% of formula; and (iv) one or more monomers having at least one vinyl or allyl reactive group, ranging from 0 to about 20% of formula.

The term SHPP is referring hereinafter to at least partially branched polyolefin, and most particularly to polypropylene, wherein the branches are planar or bulky matter, e.g., 2-D or 3-D comb-like, fork-like, star-like configurations or any combination thereof.

It is according to yet another embodiment of the present invention, as schematically illustrated in FIG. 3, wherein unsaturated acid, anhydride monomers (31) are also introduced to the reaction (30), and effectively admixed with the polypropylene chains (1) and the BNMs (21, 22), so that branched SHPP is obtained (33, 34).

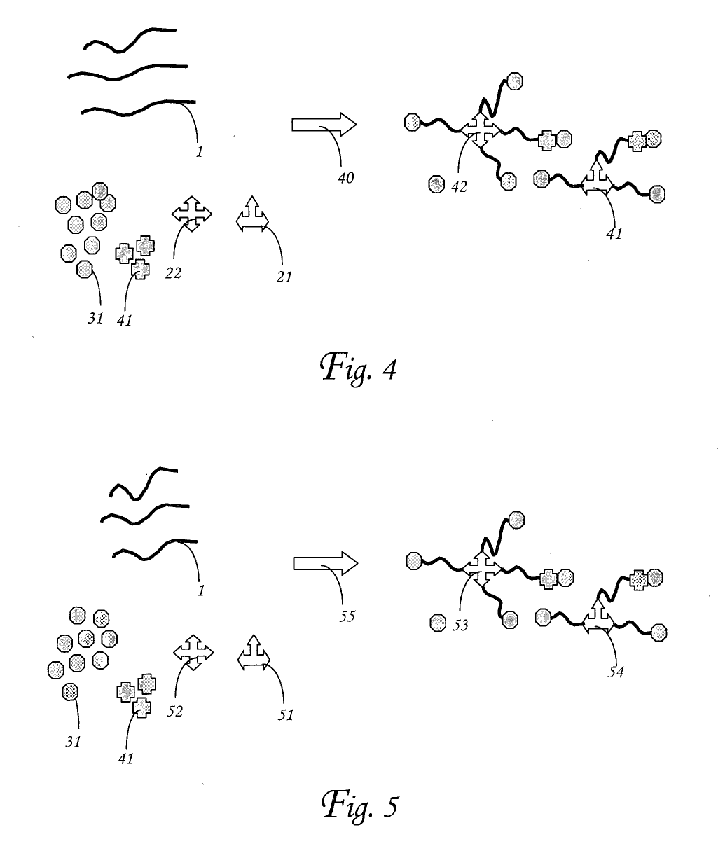

It is according to still another embodiment of the present invention, as schematically illustrated in FIG. 4, wherein maleated SHPP compounds (e.g., 41, 42) are produced by contentiously reacting polypropylene (1), maleic anhydride (31), diacrylate ester, triacrylate ester, styrene (41) and organic peroxide in co-rotating twin screw extruder.

It is according to still another embodiment of the present invention, as schematically illustrated in FIG. 5, wherein maleated SHPP compounds (e.g., 53, 54) are produced by contentiously process (55) of reacting polypropylene (1), maleic anhydride (31), higly polar di-acrylate ester, tri-acrylate ester, without or in the presence of styrene (51, 52) and organic peroxide in co-rotating twin screw extruder. Those di- and tri-acrylate is highly polar and may having high content of carboxylic groups or polyalkelene oxide segments, so the final polarity is far better than a non treated maleated polypropylene.

The polypropylene (homopolymer or copolymer) may be in the form of pellets or powder. The level of the polypropylene resin is in the range of about 80 to 99% of formula, most favorably in the range of about 95 to 99% (±15%).

The level of the unsaturated acid and derivatives thereof is in the range of 0 to about 5% of formula, most favorable about 0.5 to 2% (±15%).

Maleic anhydride is the most favorable unsaturated monomer, due to its tendency to graft onto the polymer rather to homo-polymerize. Since maleic anhydride is reactive only to a moderate measure, large fraction of it is lost during reactive extrusion (i.e., sublimation), and it causes severe environmental problems. A monofunctional co-monomer, styrene or ester of acrylic acid for example, can regulate grafting by creation of low molecular weight chains and by increase of initiation points along the chain. This monofunctional monomer is usually in the range of 0-20% of the formula and more favorable in the range of about 0.2 to 1%.

The multifunctional monomers (namely, BNMs) are having two or more vinyl or allyl reactive groups, thus able to form a branch point when grafted onto polypropylene to form a branched or partially cross-linked polypropylene with novel structure described in FIG. 1. This monomer is usually in the range of 0 to about 20% of the formula and more favorable in the range of about 0.2 to 2%

It is well in the scope of the present invention wherein one family of said BNM is acrylic or methacrylic ester monomer or oligomer, and especially those containing short aliphatic, aromatic, polyol, polyester or polyurethane segment, that in one hand has the grafting advantages of styrene and in the other hand has low volatily and low odor. Another advantage of this novel co-monomer family is the possibility to introduce extra polarity (e.g., via ethoxylated monomers) extra acidity (e.g., via acid containing monomers) extra heat stability (e.g., via aromatic and metal di-acid monomers) secondary cross-linking sites (e.g., via hydroxyl or glycidyl terminated monomers). The level of the co-monomer, denoted hereinafter to the sum of all mono and higher acrylate or methacrylate monomers, is in the range of about 0.2 to 20% of formula, most favorable about 0.2 to 2%

It is also in the scope of the present invention wherein the BNM comprising multifunctional vinyl or allyl BNM oligomers, vinyl esters, vinyl ethers, alkyd, unsaturated polyester, vinyl terminated PDMS, 1,2 Polybutadiene, acrylic and methacrylic esters of polyhydric alcohols, such as trimethylolpropanetriacrylate.

Free radical initiator is usually decomposed under heat to form free radicals. Organic peroxides are the preferred initiators, for example ditertiary butyl peroxide, tertiary butyl hydroperoxide, cumene hydroperoxide, p-menthane peroxide, p-menthane hydroperoxide and 2,5-dimethyl-2,5-bis-(t-butylperoxy)hexane.

### EXAMPLE

MA was grafted in PP with diacrylate and triacrylate as BNM. Polypropylene homopolymer, i.e., commercially available product by Carmel olefins, G-86E PP homopolymer, MFI=3 at 230° C./2.16 kg, polypropylene copolymer, commercially available product Carmel olefins, TG-50 PP copolymer, MFI=3.5 at 230° C./2.16 kg, Maleic anhydride, aliphatic diacrylate commercially available product SR 9003 by Sartomer, aliphatic triacrylate commercially available product SR 454 by Sartomer, initiator having T½ of 1 minutes at 180 commercially available product Luperox 101 by Elf Atochem, were premixed in ribbon mixer at ambient for 30 minutes and stored in sealed container.

The mixture was fed into co-rotating twin-screw extruder having L/D of 40 and screw configuration designed for residence time of 80 seconds at 200 RPM, with vacuum venting port at the last portion of extruder. The feeding zone was held at 100° C. to avoid loss bv volatiles monomers before melting of PP takes place. The reaction was carried at 220° C. The product has light yellow color; very mild odor. The MFI was measured according to standard ASTM. The Maleic anhydride content was determined by FTIR method. the properties are described in table 2

TABLE 1
Various compositions comprising MA PP with
diacrylate and triacrylate as BNM

| | | | | | | | | |
|---|---|---|---|---|---|---|---|---|
| maleic | 1 | 1 | 1 | 1 | 1 | 1 | 1 | 1 |
| anhydride | | | | | | | | |
| Luperox 101 | 0.25 | 0.25 | 0.25 | 0.35 | 0.35 | 0.35 | 0.25 | 0.25 |
| G-86E PP | 98.75 | 98.75 | 98.75 | 0 | 0 | 0 | 93.75 | 93.75 |
| homo | | | | | | | | |
| polymer | | | | | | | | |
| TG-50 PP | 0 | 0 | 0 | 98.65 | 98.65 | 98.65 | 0 | 0 |
| co-polymer | | | | | | | | |
| SR454 tri | 0 | 1 | 0 | 0 | 1 | 0 | 0 | 5 |
| acrylate | | | | | | | | |
| SR 9003 | 0 | 0 | 1 | 0 | 0 | 1 | 5 | 0 |
| diarylate | | | | | | | | |

TABLE 2
Properties of modified PP

| | formula 1 | formula 2 | formula 3 | formula 4 | formula 5 | formula 6 | formula 7 | formula 8 |
|---|---|---|---|---|---|---|---|---|
| maleic | 0.65 | 0.84 | 0.87 | 0.67 | 0.74 | 0.79 | 1.14 | 0.82 |
| anhydride | | | | | | | | |
| MFI at | 220 | 203 | 173 | 100 | 70 | 81 | 59 | 71 |
| 190 C./ | | | | | | | | |
| 2.16 Kg | | | | | | | | |

Formula 1 is a control sample for PP homo polymer. MFI was found to be very high (e.g., 220) and the measure of maleic anhydride grafting is medium (e.g., 0.65%). Formula 4 is a control sample for PP impact co-polymer, utilized for ethylene propylene rubber and PP homo polymer. MFI measure is lower than the homo-polymer due to the rubber cross-linking (220) but the measure of maleic anhydride grafting is medium (e.g., 0.67%), a similar value in compare with the homo-polymer. Formula 2, comprising 1% triacrylate, comprising 0.19% more maleic anhydride grafted, wherein MFI is lowered by 17 units compared to its control, i.e., formula 1.

Formula 3 comprising 1% diacrylate, has 0.22% more grafting of maleic anhydride grafted and the MFI is lowered by 47 units compared to its control defined as formula 1.

It is hereto suggested in a non-limiting manner that the better influence of the diacrylate is due to the lower molecular weight, whereat more functional groups are provided per composition (1%). Similar results are found in the co-polymer, see formulas 4 to 6.

In formulas 7 and 8, an increase in BNM content to 5%, dramatically increases the degree of maleic anhydride grafting and provided for a decrease in MFI values. Reference is especially made to Formula 7 showing a combination of very high maleic anhydride level (e.g., 1.14%) and MFI value (e.g., 59) which is about 20% of the expected from the maleic anhydride content in standard grafting process.

This novel method is very important for application where high coupling efficiency and high mechanical and thermal properties are required.

1. A composition of matter comprising a star-like high polypropylene (SHPP); said polypropylene is manufactured by a continuous reactive process at molten phase and characterized by a comb-like, fork-like and/or star-like molecular structure, comprising:
a. polypropylene, ranging from about 80 to 99% of formula;
b. free-radical initiator having T_{1/2} of at least 1 min at temperature higher than 100° C., ranging from about 0.01 to 2% of formula;
c. one or more branching nucleus monomers (BMN) having two or more vinyl or allyl reactive groups, adapted to form at least one branch point when grafted onto said polypropylene, ranging from about 0.1 to 20% of formula; and,
d. one or more monomers having at least one vinyl or allyl reactive group, ranging from 0 to about 20% of formula.

2. The composition according to claim 1, wherein the polypropylene is a homopolymer.

3. The composition according to claim 1, wherein the polypropylene is a copolymer having about 1 to 80% co-monomer in formula.

4. The composition according to claim 1, wherein the BNM is characterized by the formula of R1;R2;R3(R4, R5); wherein at least R1 is acrylic or methacrylic group, chemically connected to R2 via an ester group; wherein R2 is mono, di or oligomeric ether, ester and/or urethane chain, connected to R3 via either ester or ether group; wherein R3 has a plurality of M acrylate or methacrylate ester side groups, denoted as R4, connected to R3 via an ester group, wherein n is an integer number so that n≧0; and further wherein R5 is H, OH, CH₃, glycidyl, acrylate or methacrylate ester, carboxyl or anhydride thereof connected to R3 via an ester group.

5. The composition according to claim 1, wherein the BNM is comprised of at least one of the group of vinyl esters, vinyl ethers, alkyd, unsaturated polyester, vinyl terminated PDMS, 1,2 polybutadiene, acrylic and methacrylic esters of polyhydric alcohols or any combinaton thereof.

6. The composition described in claim 1, wherein the matter is pelletizable.

7. A composition of matter comprising a modified polar SHPP; said polypropylene is manufactured by a continuous reactive process at molten phase and characterized by a fork-like and/or star-like molecular-structure, comprising:
a. polypropylene ranging from about 80 to 99% of formula;
b. free radical initiator having T_{1/2} of at least minute at temperature higher than 100° C., ranging from about 0.01 to 2% of formula;
c. one or more BNM monomers having two or more vinyl or allyl reactive groups ranging from about 0.1 to 20% of formula, adapted to form at least one branch point when grafted onto polypropylene;
d. one or more monomers having at least one vinyl or allyl reactive group, ranging from 0 to about 20% of formula;
e. unsaturated acid monomer having at least one vinyl or allyl reactive groups and one or more carboxylic acid or anhydride or ester group, ranging from about 0.1 to 5% of formula.

8. The composition according to claim 7, wherein the polypropylene is a homopolymer.

9. The composition according to claim 7, wherein the polypropylene is a copolymer having about 1 to 80% co-monomer in formula.

10. The composition according to claim 7, wherein the unsaturated acid or any of its derivatives are selected from one or more of the group of maleic acid, esters or anhydride; acrylic acid, esters or anhydride; methacrylic acid, esters and anhydride or any mixture thereof.

11. The composition described in claim 7, wherein the BNM is characterized by the formula of R1;R2;R3(R4, R5); wherein at least one R1 is acrylic or methacrylic group, chemically connected to R2 via an ester group; wherein R2 is mono, di- or oligomeric ether, ester and/or urethane chain, connected to R3 via either ester or ether group, wherein R2 is either a short polyester or polyurethane; wherein R3 has a plurality of n acrylate or methacrylate ester side groups, denoted as R4, connected to R3 via an ester group, wherein n is an integer number so that n≧0; and further wherein R5 is H, OH, CH₃, glycidyl, acrylate or methacrylate ester, carboxyl or anhydride thereof connected to R3 via an ester group.

12. The composition according to claim 7, wherein the BNM is selected from at least one of the group of vinyl esters, vinyl ethers, alkyd, unsaturated polyester, vinyl terminated PDMS, 1,2 polybutadiene, acrylic and methacrylic esters of polyhydric alcohols or any combination thereof.

13. The composition according to claim 7, adapted to couple polyolefines with fillers and fibers.

14. The composition according to claim 13, wherein the fibers are synthetic fibers, natural fibers or any mixture thereof.

15. The composition according to claim 14, wherein the fibers are selected from wood, flour, glass, silica, minerals, metal, ceramic and organic pigments.

16. The composition according to claim 7, useful as an adhesive or adhesive building-block compositions for bonding plastics with at least one polar substrate.

17. The composition according to claim 16, wherein the polar substrate is selected from wood, paper, metals, polar plastics, glass, ceramics or a combination thereof.

18. The composition according to claim 7, useful as a compatibilizer, having means for compatibiling incompatible thermoplastics.

19. The composition according to claim 18, wherein the incompatible thermoplastics are selected from polypropylene/polyamide and/or polypropylene/polyester mixtures.

20. The composition according to claim 7, useful as a dispersing agent for pigments and/or nano-sized particles in plastic matrices.

21. The composition according to claim 7, useful as a primer for coatings and adhesives when applied onto plastic or natural polymers surfaces prior to application of coating or adhesive.

22. The composition described in claim 7, wherein the matter is pelletizable.

23. A continuous reactive process for producing SHPP as defined in claim 1, comprising inter alia the steps of:
a. pre-mixing all ingredients so a homogeneous dry, free flowing pellets or powder blend is obtained;
b. During mixing, immobilizing the maleic anhydride dust by the liquid monomers into the polymer pellets or powder.
c. Feeding the obtained free flowing mixture, by known feeding means into an extruder; while heating the first zone of extruder to a temperature ranging from about 50 to 130° C. in the manner that the monomers and the initiator on the polymer pellets or powder are distributed evenly and the initiator is minimally activated; and,
d. reacting the ingredients under extensive mixing in the extruder at temperature range of about 160 to 235° C., residence time of about 0.5 to 3 minutes, screw speed of about 100 to 450 RPM, with a contentious removal of volatile materials under vacuum at the last section of extruder and contentious collecting the reacted product as palletizeable compound.

24. A continuous reactive process for producing SHPP as defined in claim 7, comprising inter alia the steps of:
a. pre-mixing all ingredients so a homogeneous dry, free flowing pellets or powder blend is obtained;
b. During mixing, immobilizing the maleic anhydride dust by the liquid monomers into the polymer pellets or powder.
c. Feeding the obtained free flowing mixture, by known feeding means into an extruder; while heating the first zone of extruder to a temperature ranging from about 50 to 130° C. in the manner that the monomers and the initiator on the polymer pellets or powder are distributed evenly and the initiator is minimally activated; and,
d. reacting the ingredients under extensive mixing in the extruder at temperature range of about 160 to 235° C., residence time of about 0.5 to 3 minutes, screw speed of about 100 to 450 RPM, with a contentious removal of volatile materials under vacuum at the last section of extruder and contentious collecting the reacted product as palletizeable compound.
